(19) United States
(12) Patent Application Publication
(10) Pub. No.: US 2023/0004514 A1
(43) Pub. Date: Jan. 5, 2023

(54) COMMUNICATION PROTOCOLS FOR SECURE DIGITAL (SD) CARDS

(71) Applicant: HEWLETT-PACKARD DEVELOPMENT COMPANY, L.P., Spring, TX (US)

(72) Inventors: Monji G. Jabori, Spring, TX (US); Rahul Lakdawala, Spring, TX (US); Jonathan Vu, Spring, TX (US)

(73) Assignee: HEWLETT-PACKARD DEVELOPMENT COMPANY, L.P., Spring, TX (US)

(21) Appl. No.: 17/784,844

(22) PCT Filed: Dec. 12, 2019
(86) PCT No.: PCT/US2019/066050

§ 371 Date: Jun. 13, 2022

(51) Int. Cl. G06F 13/40; G06F 13/42

(52) U.S. Cl. CPC G06F 13/409; G06F 13/4221

(57) ABSTRACT

In some examples, a system comprises: a socket; a controller coupled to the socket; a storage device comprising machine-readable instructions; and a processor coupled to the controller and the storage device, wherein execution of the machine-readable instructions causes the processor to: detect a Secure Digital (SD) card in the socket via the controller; prompt a user to select a communication protocol to be utilized by the system to communicate with the SD card; and enable the system to communicate with the SD card based on the user selection.

### BACKGROUND

Secure Digital (SD) slots, or sockets, of an electronic device host SD cards, which provide additional memory capacity for the electronic device. The specification that guides the design and support of SD cards enables backward compatibility, so the electronic device may support legacy SD cards as well as next generation SD cards. For example, a legacy SD card may utilize an SD 3.0 communication protocol, while a next generation SD card may utilize the SD 3.0 communication protocol as well as a Peripheral Component Interconnect Express (PCIE®) communication protocol.

### BRIEF DESCRIPTION OF THE DRAWINGS

Various examples will be described below referring to the following figures:

FIG. 1 is a schematic diagram of a system for enabling a communication protocol, in accordance with various examples;

FIG. 2 is a schematic diagram of a system for enabling a communication protocol with an SD card, in accordance with various examples;

FIG. 3 is a schematic diagram of a system for enabling a communication protocol with a next generation SD card, in accordance with various examples;

FIG. 4 is a schematic diagram of a system for determining a communication protocol, in accordance with various examples;

FIG. 5 is a schematic diagram of a system for enabling a communication protocol with an SD card, in accordance with various examples;

FIG. 6 is a flow diagram of a method for determining a communication protocol with an SD card, in accordance with various examples; and

FIG. 7 is a flow diagram of a method for enabling a communication protocol with an SD card, in accordance with various examples.

### DETAILED DESCRIPTION

As explained above, an electronic device may include a socket that supports both legacy SD cards as well as next generation SD cards. For example, the socket may support both an SD High Capacity (SDHC) card (e.g., legacy SD card) as well as an SD Express card (e.g., next generation SD card). Depending on whether an SD card is a legacy SD card or a next generation SD card, the electronic device may communicate with the SD card utilizing a legacy communication protocol alone or either the legacy communication protocol or a next generation communication protocol. For example, an SDHC card may utilize an SD 3.0 (SD3.0) communication protocol alone, while an SD Express card may utilize either the legacy SD3.0 communication protocol or the next generation Peripheral Component Interconnect Express (PCIE) communication protocol. As SD cards evolve and communication protocols evolve, what is currently next generation may become legacy and the latest evolution may become the next generation.

The PCIE communication protocol allows direct communication between the SD card and components of the electronic device (e.g., bus mastering). Because content of the SD card does not first go through a processor of the electronic device, the electronic device has faster access to information stored on the SD card. However, the direct communication also leaves the electronic device vulnerable to malicious executable code that may be stored in the content of the SD card. The SD3.0 communication protocol provides a security layer between the electronic device and the content of the SD card. Communications between the electronic device and the SD card are handled by a controller and access to the components of the electronic device by the content of the SD card is limited.

This disclosure describes various examples of a system that enables a user to select a communication protocol to utilize after an SD card is inserted into a socket of the system. For example, the system may detect an SD Express card in the socket. The system may prompt the user to select a desired communication protocol. In some examples, the system may block communications with the SD card until the user selects a communication protocol. In response to the user selection, the system may enable communications with the SD card utilizing the communication protocol.

In one example in accordance with the present disclosure, a system is provided that includes a socket, a controller coupled to the socket, a storage device comprising machine-readable instructions, and a processor coupled to the controller and the storage device. Execution of the machine-readable instructions causes the processor to: detect a Secure Digital (SD) card in the socket via the controller; prompt a user to select a communication protocol to be utilized by the system to communicate with the SD card; and enable the system to communicate with the SD card based on the user selection.

In another example in accordance with the present disclosure, a machine-readable medium is provided. The machine-readable medium is a non-transitory medium that stores machine-readable instructions which, when executed by a processor, cause the processor to detect a Secure Digital Express (SDExpress) card in a socket and prompt a user for a communication protocol to be utilized when communicating with the SDExpress card.

In yet another example in accordance with the present disclosure, a method is provided. The method comprises: detecting a Secure Digital (SD) card in a socket coupled to a controller; determining whether the SD card is an SDExpress card; and, in response determining that the SD card is an SDExpress card, prompting a user for a communication protocol to be utilized when communicating with the SDExpress card.

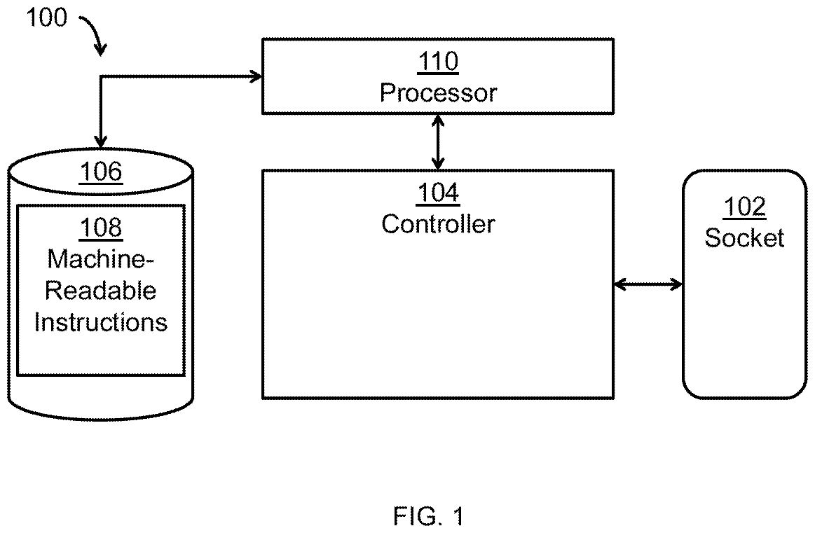

FIG. 1 is a schematic diagram of a system 100 for enabling a communication protocol, in accordance with various examples. The system 100 comprises a controller 104 coupled to a socket 102 and a processor 110. The processor 110 couples to a storage device 106. The system 100 may be an electronic device such as a desktop, a laptop, a notebook, a tablet, a smartphone, a mobile device, a digital camera, a television, a portable game device, a printer, a Digital Versatile Disc (DVD) recorder, or some other electronic device utilizing memory, for example. For example, the socket 102 may be a slot for removable memory, such as a Secure Digital (SD) card. The controller 104 may be a microprocessor, a microcontroller, a microcomputer, or other suitable processor, for example. The storage device 106 may be a hard drive, solid state drive (SSD), flash memory, random access memory (RAM), or other suitable memory, for example. The processor 110 may be a microprocessor, a microcomputer, a microcontroller, or another suitable processor or controller, for example. In some examples, the storage device 106 may store machine-readable instructions 108, which, when executed, cause the processor 110 to perform some or all of the actions attributed herein to the processor 110.

In various examples, the socket 102 may accept a Standard-Capacity (SDSC) card, a High-Capacity (SDHC) card, an eXtended-Capacity (SDXC) card, an Ultra-Capacity (SDUC) card, an Input Output (SDIO) card, an Express (SDExpress) or any other legacy SD card or next generation SD card. The socket 102 may accommodate a miniSD, a microSD, a standard SD card, or any other legacy SD card size or next generation SD card size, for example. As SD cards evolve, what is currently next generation may become legacy and the latest evolution may become the next generation.

In some examples, the controller 104 may be installed at manufacture. The installation of the controller 104 may include storing, on the storage device 106, machine-readable instructions (e.g., a device driver) for interacting with the controller 104. The device driver of the controller 104 may be stored on the storage device 106 as machine-readable instructions 108, for example. Execution of the device driver of the controller 104 may cause the processor 110 to perform some or all of the actions attributed herein to the processor 110.

In other examples, the controller 104 may comprise a storage device. The storage device may be flash memory, random access memory (RAM), or other suitable memory, for example. In various examples, the storage device of the controller 104 may comprise machine-readable instructions. The machine-readable instructions may cause the controller 104 to perform some or all of the actions attributed herein to the controller 104. In yet other examples, the storage device of the controller 104 may include a register. The register contains data such as addresses, truth values, and numeric values. When the controller 104 detects a card in the socket 102, the register of the controller 104 may be updated to indicate that the socket 102 contains a card. The controller 104 may communicate with the card in the socket 102 to determine the type of card. The register of the controller 104 may be updated to indicate the type of card in the socket 102. In some examples, after the controller 104 determines the type of card in the socket 102, the controller 104 may block a communication path between the controller 104 and the socket 102 until a security of the card in the socket 102 can be verified (e.g., verify the user trusts the source and/or contents of the card). The controller 104 may request, from the device driver of the controller 104, a communication protocol to enable. In various examples, the controller 104 may block the communication path between the controller 104 and the socket 102 until the device driver of the controller 104 responds with the communication protocol.

In various examples, a register may be stored on the storage device 106. For example, the register stored on the storage device 106 may be part of the Basic Input/Output System (BIOS), Unified Extensible Firmware Interface (UEFI), or another specification for machine-readable instructions that connect machine-readable instructions of an operating system of a computing device to machine-readable instructions that control embedded systems of the computing device. The register stored on the storage device 106 may indicate a default communication protocol. For example, the register may indicate a default communication protocol of SD3.0. In another example, the register may indicate a default communication protocol of PCIE. In some examples, the register may be set to a default communication protocol at manufacture. In other examples, the register may be set by a user with an appropriate level of administrative privileges for the system 100. For example, if the system 100 belongs to an enterprise (e.g., business, company), then the enterprise may set the default communication protocol to SD3.0 to protect the security of the system 100. In another example, a user of the system 100 may be more concerned with access time and set the default communication protocol to PCIE.

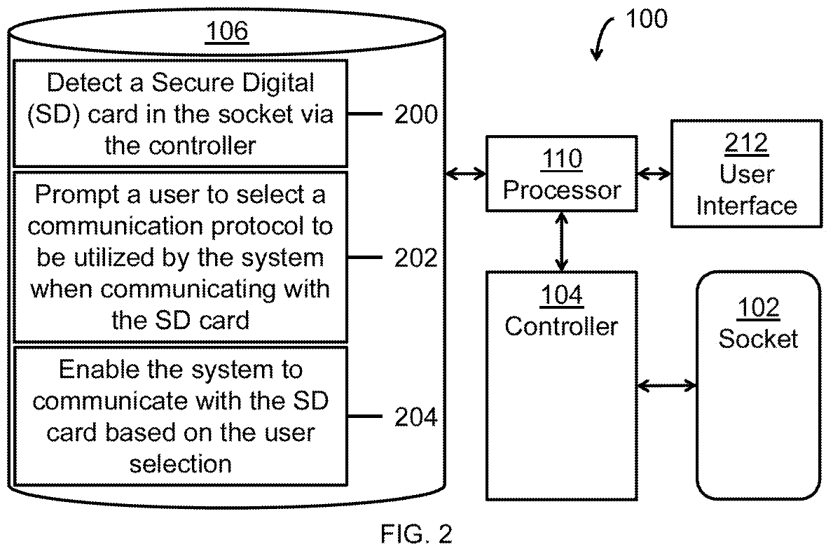

FIG. 2 is a schematic diagram of the system 100 system for enabling a communication protocol with an SD card, in accordance with various examples. As discussed above with respect to FIG. 1, the system 100 may be an electronic device. The system 100 may also comprise a user interface 212 coupled to the processor 110. For example, the user interface 212 may be machine-readable instructions that, when executed, cause the processor 110 to cause the display to present options from which a user selects and to collect the user selection. In some examples, the options may be presented on a display (e.g., monitor) of the system 100. The user selection may be collected from an input peripheral device (e.g., keyboard, touchscreen, mouse) of the system 100. The machine-readable instructions of the user interface 212 may be stored on the storage device 106 as machine-readable instructions 108, for example. Execution of the machine-readable instructions of the user interface 212 may cause the processor 110 to perform some or all of the actions attributed herein to the processor 110.

In some examples, the storage device 106 may store machine-readable instructions 200, 202, and 204. The machine-readable instructions 200, 202, 204 may be machine-readable instructions 108, for example. The machine-readable instructions 200, 202, 204 may be for execution by the processor 110. The machine-readable instructions 200, 202, 204 may cause the processor 110 to detect a SD card and enable the system 100 to communicate with the SD card. Execution of instruction 200 may cause the processor 110 to detect an SD card in the socket 102 via the controller 104. Execution of instruction 202 may cause the processor 110 to cause a display to show a prompt for a communication protocol to be utilized by the system 100 when communicating with the SD card. Execution of instruction 204 may cause the processor 110 to enable the system 100 to communicate with the SD card based on the user selection.

As discussed above with respect to FIG. 1, in some examples, the controller 104 detects a card in the socket 102 and updates the register of the controller 104. Updating the register of the controller 104 may cause a signal to be sent to the processor 110 to indicate a card is in the socket 102. In other examples, the controller 104 sending the signal to request the communication protocol from the device driver of the controller 104, as discussed above with respect to FIG. 1, notifies the processor 110 that a card is in the socket 102. After the processor 110 detects the signal (e.g., updated register, request for communication protocol), the processor 110 may read the register of the controller 104 to determine what type of card is in the socket 102. In yet another example, the processor 110 may communicate with the controller 104 to instruct the controller 104 to communicate with the card in the socket 102 to determine the type of card.

In other examples, in response to determining that an SD card is the card in the socket 102, the processor 110 may prompt the user to select a communication protocol compatible with the SD card detected. For example, if the SD card is a legacy SD card, the processor 110 may prompt the user to verify the communication protocol is SD3.0. In another example, if the SD card is an SDExpress card, the processor 110 may prompt the user to select between PCIE and SD3.0 communication protocols. As discussed above with respect to FIG. 1, the user interface 212 may cause the processor 110 to prompt the user for the communication protocol to be utilized by the system 100 to communicate with the SD card.

In yet other examples, the user interface 212 may cause the processor 110 to present an option to the user to set a communication protocol as the default communication protocol. As discussed above with respect to FIG. 1, a register comprising the default communication protocol may be stored on the storage device 106. If the user elects to set the communication protocol as the default communication protocol, then the processor 110 may update the register. In some instances, the user may change the default communication protocol stored in the register on the storage device 106 by executing the user interface 212 independent of the detection of a card in the socket 102.

In various examples, the user interface 212 may cause the processor 110 to present an option to the user to prevent the processor 110 from causing future prompts to the user for a communication protocol. If the user indicates the processor 110 should not prompt the user for a communication protocol in the future, the processor 110 may set a flag stored on the storage device 106. For example, the register stored on the storage device 106 may include the flag. After detecting a card in the socket 102, the processor 110 may determine if the flag is set. If the flag is set, then the processor 110 may not prompt the user for a communication protocol. Instead, the processor 110 may utilize the default communication protocol stored in the register of the storage device 106. In other examples, the processor 110 may default to the most secure communication protocol (e.g., SD3.0). In yet other examples, the processor 110 may default to the communication protocol that provides the fastest access (e.g., PCIE).

In other examples, the user interface 212 may cause the processor 110 to present the user an option for the system 100 to trust the security of the SD card in the socket 102. For example, the user interface 212 may ask the user if the source and/or contents of the SD card are trusted. If the user indicates the security of the SD card is trusted, then the processor 110 may request an identifier from the SD card in the socket 102. In some examples, as discussed above with respect to FIG. 1, the controller 104 may block the communication path until the security of the SD card is verified. Once the user indicates the security of the SD card is trusted, then the controller 104 may unblock the communication path. For example, the processor 110 may signal the controller 104 to enable communications to indicate the security of the SD card is trusted. The processor 110 may receive the identifier of the SD card. For example, as discussed above, the controller 104 may store the identifier of the SD card in the register of the controller 104. The processor 110 may receive the identifier of the SD card by reading the register of the controller 104. In another example, the processor 110 may receive the identifier of the SD card by reading a register of the SD card. In various examples, the processor 110 may store the identifier on the storage device 106. For example, the identifier may be stored in a data structure (e.g., list, database). In some examples, the processor 110 may store the user-selected communication protocol in the data structure with the identifier stored on the storage device 106.

In yet other examples, after detecting a SD card in the socket via the controller 104, the processor 110 may request the identifier from the SD card in the socket 102. After receiving the identifier, the processor 110 may compare the identifier to the list of stored identifiers on the storage device 106. If the identifier is on the list of stored identifiers, then the processor 110 may utilize the communication protocol associated with the identifier to communicate with the SD card. In other examples, prior to utilizing the stored communication protocol, the processor 110 may prompt the user to determine if the SD card remains trusted. If the SD card is not trusted, the processor 110 may remove the identifier of the SD card from the stored data structure.

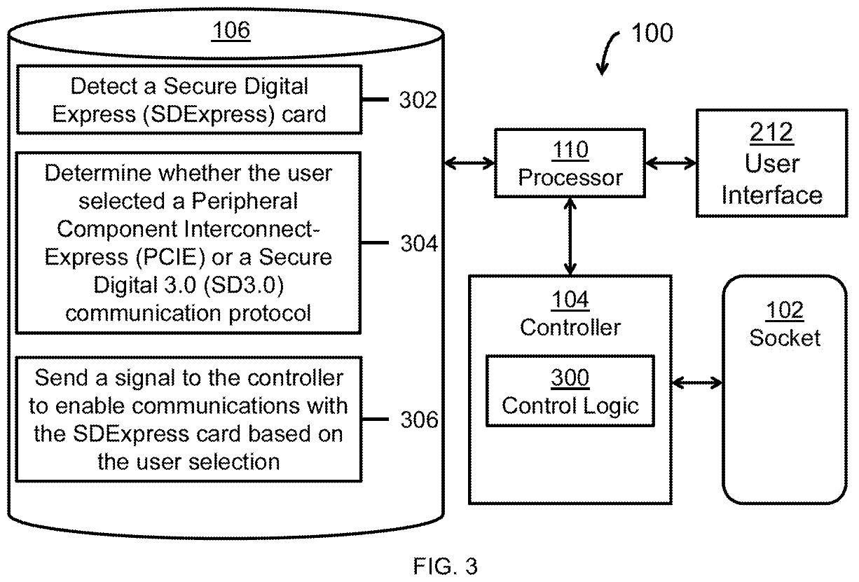

FIG. 3 is a schematic diagram of the system 100 for enabling a communication protocol with a next generation SD card, in accordance with various examples. As discussed above with respect to FIGS. 1 and 2, the system 100 may comprise the socket 102, the controller 104, the storage device 106, and the processor 110. As discussed above with respect to FIG. 2, the system 100 may also comprise the user interface 212 coupled to the processor 110. The controller 104 may comprise a control logic 300. The control logic 300 may be a multiplexer, digital logic gates, or some other electronic component or circuitry that allows switching between communication paths or buses.

In some examples, the storage device 106 may store machine-readable instructions 302, 304, and 306. The machine-readable instructions 302, 304, 306 may be machine-readable instructions 108, for example. The machine-readable instructions 302, 304, 306 may be for execution by the processor 110. The machine-readable instructions 302, 304, 306 may cause the processor 110 to detect an SDExpress card and send a signal to the controller 104 to enable communications with the SDExpress card. Execution of instruction 302 may cause the processor 110 to detect the SDExpress card. Execution of instruction 304 may cause the processor 110 to determine whether the user selected a PCIE or an SD3.0 communication protocol. Execution of instruction 306 may cause the processor 110 to send a signal, based on the selection, to set the control logic 300 to enable either PCIE communications or SD3.0 communications.

As discussed above with respect to FIGS. 1 and 2, the controller 104 may detect a card in the socket 102. In some examples, the controller 104 may determine the card in the socket 102 is a next generation SD card. For example, the controller 104 may read a register of the card in the socket 102 to determine the card is an SDExpress card. The controller 104 may update the register of the controller 104 to indicate a next generation SD card is in the socket 102. As discussed above with respect to FIG. 2, updating the register of the controller 104 may send a signal to the processor 110. The processor 110 may read the register of the controller 104 to determine a next generation card is in the socket 102. In other examples, the processor 110 may read the register of the card in the socket 102 to determine the card is a next generation SD card. The processor 110 may prompt the user to select either a legacy communication protocol or a next generation communication protocol. For example, if the card is an SDExpress card, then the user interface 212 may cause the processor 110 to prompt the user to select either the legacy SD3.0 communication protocol or the next generation PCIE communication protocol. Based on the user selection, the processor 110 may send a signal to the controller 104 to enable communications with the next generation SD card. In some examples, the signal causes the controller 104 to close a switch of the control logic 300 associated with the selected communication protocol. For example, if the user selects the SD3.0 communication protocol, then the controller 104 closes the switch of the control logic 300 associated with the SD3.0 communication protocol. In another example, if the user selects the PCIE communication protocol, then the controller 104 closes the switch of the control logic 300 associated with the PCIE communication protocol.

As discussed above with respect to FIGS. 1 and 2, in some examples, the controller 104 may block the communication path with the socket 102. For example, as discussed above with respect to FIG. 1, the controller 104 may block the communication path with the socket 102 until a security of a card in the socket 102 is verified. In another example, as discussed above with respect to FIG. 2, the controller 104 may block the communication path with the socket 102 until the controller 104 receives a communication protocol from the device driver of the controller 104. In various examples, the controller 104 may block the communication path by opening the switches of the control logic 300.

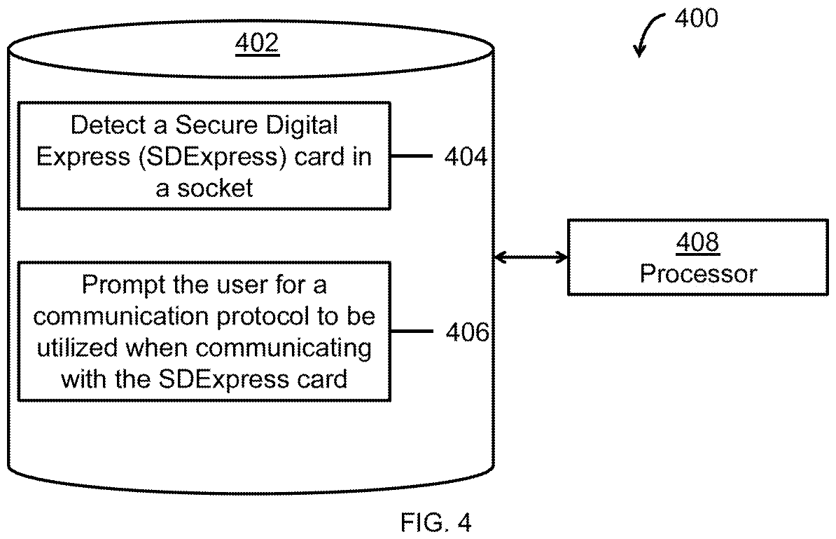

FIG. 4 is a schematic diagram of a system 400 for determining a communication protocol, in accordance with various examples. The system 400 comprises a machine-readable medium 402 and a processor 408 coupled to the machine-readable medium 402. The system 400 may be the system 100, for example. The system 400 may be an electronic device, as discussed above with respect to FIG. 1, for example. The machine-readable medium is a non-transitory medium that stores machine-readable instructions. The non-transitory medium includes all electronic mediums of storage, expect signals. The machine-readable medium 402 may be a storage device such as a hard drive, solid state drive (SSD), flash memory, random access memory (RAM), or other suitable memory, for example. The machine-readable medium 402 may be the storage device 106, for example. The processor 408 may be a microprocessor, a microcomputer, a microcontroller, or another suitable processor or controller, for example. The processor 408 may be the processor 110, for example. The machine-readable medium 402 may store machine-readable instructions, which, when executed, cause the processor 408 to perform some or all of the actions attributed herein to the processor 408.

The machine-readable medium 402 comprises machine-readable instructions 404 and 406. The machine-readable instructions 404, 406 may be machine-readable instructions 108, for example. The machine-readable instructions 404, 406 may be machine-readable instructions for execution by the processor 408. Execution of the machine-readable instructions 404, 406 may cause the processor 408 to detect an SDExpress card in a socket (e.g., 102) and prompt the user for a communication protocol. Execution of machine-readable instruction 404 may cause the processor 408 to detect the SDExpress card in the socket. Execution of machine-readable instruction 406 may cause the processor 408 to prompt the user for the communication protocol to be utilized when communicating with the SDExpress card.

As discussed above with respect to FIGS. 1, 2, and 3, the processor 408 may detect an SDExpress card in the socket via a controller (e.g., 104). For example, the processor 408 may receive a signal from the controller. In response to the signal, the processor 408 may read a register of the controller to determine a type of the card in the socket, in an example. In another example, the processor 408 may read a register of the card in the socket. As discussed above with respect to FIGS. 2 and 3, the processor 408 may prompt the user for a communication protocol to be utilized when communicating with the SDExpress card. For example, machine-readable instructions of a user interface (e.g., 212) may prompt the user to select either a PCIE or an SD3.0 communication protocol.

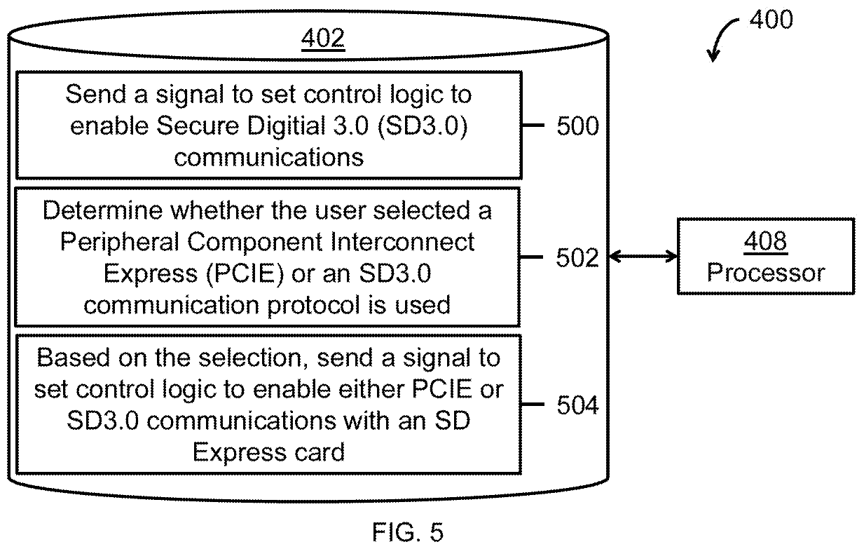

FIG. 5 is a schematic diagram of the system 400 for enabling a communication protocol with an SD card, in accordance with various examples. As discussed above with respect to FIG. 4, the system 400 comprises the machine-readable medium 402 coupled to the processor 408. The machine-readable medium 402 comprises machine-readable instructions 500, 502, and 504. The machine-readable instructions 500, 502, 504 may be machine-readable instructions 108, for example. The machine-readable instructions 500, 502, 504 may be machine-readable instructions for execution by the processor 408. Execution of the machine-readable instructions 500, 502, 504 may cause the processor 408 to send a signal to set the control logic (e.g., 300) to enable a communication protocol. Execution of machine-readable instruction 500 may cause the processor 408 to send a signal to set the control logic to enable SD3.0 communications. Execution of machine-readable instruction 502 may cause the processor 408 to determine whether the user selected a PCIE or SD3.0 communication protocol. Execution of machine-readable instruction 504 may cause the processor 408 to send a signal to set the control logic to enable either PCIE or SD3.0 communications with an SDExpress card.

As discussed above with respect to FIGS. 1 and 2, in various examples, a register indicating a default communication protocol may be stored on a storage device (e.g., 106). For example, the register may indicate a default communication protocol of SD3.0. In another example, the register may indicate a default communication protocol of PCIE. In some examples, prior to detecting a card in a socket (e.g., 102), the processor 110, 408 may send a signal to a controller (e.g., 104) to enable communications with the socket based on the default communication protocol. For example, if the register indicates a default communication protocol of SD3.0, then the controller sets the control logic (e.g., 300) to enable SD3.0 communications with the card in the socket. In another example, if the register indicates a default communication protocol of PCIE, then the controller sets the control logic to enable PCIE communications with the card in the socket.

As discussed above with respect to FIG. 4, based on the detection of an SDExpress card in the socket, the processor 408 may prompt the user to select either a PCIE or an SD3.0 communication protocol. The processor 408 may determine whether the user selected the PCIE or the SD3.0 communication protocol. For example, a user interface (e.g., 212) may instruct the processor 408 to collect the user selection from an input peripheral device, as discussed above with respect to FIG. 2. Based on the user selection, the processor 408 may send a signal to the controller to set the control logic to enable the user-selected communication protocol. For example, if the user selects a communication protocol of SD3.0, then the controller sets the control logic to enable SD3.0 communications with the card in the socket. In another example, if the user selects a communication protocol of PCIE, then the controller sets the control logic to enable PCIE communications with the card in the socket.

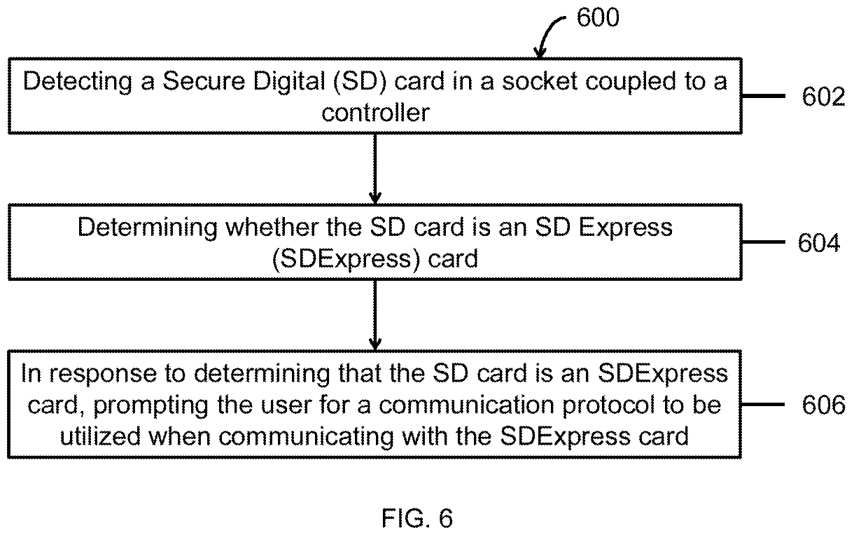

FIG. 6 is a flow diagram of a method 600 for determining a communication protocol with an SD card, in accordance with various examples. The method 600 may be performed, for instance, by the processor 110, 408. The method 600 includes detecting an SD card in a socket coupled to a controller (602). The method 600 also includes determining whether the SD card is an SDExpress card (604). In addition, the method 600 includes, in response to determining that the SD card is an SDExpress card, prompting a user for a communication protocol to be utilized when communicating with the SDExpress card (606).

As discussed above with respect to FIGS. 1, 2, 3, and 4, the processor 110, 408 may detect an SD card in the socket via a controller (e.g., 104). For example, the processor 110, 408 may receive a signal from the controller. In response to the signal, the processor 110, 408 may read a register of the controller to determine a type of the card in the socket, in one example. In another example, the processor 110, 408 may read a register of the card in the socket. As discussed above with respect to FIGS. 1, 2, and 4, the processor 110, 408 may determine a type of the card in the socket. The processor 110, 408 may read a register of the controller to determine a type of the card in the socket, in one example. In another example, the processor 110, 408 may read a register of the card in the socket. In response to determining the type of the card in the socket is SDExpress, the processor 110, 408 may prompt the user for a communication protocol to be utilized when communicating with the SDExpress card. For example, machine-readable instructions of a user interface (e.g., 212) may prompt the user to select either a PCIE or an SD3.0 communication protocol.

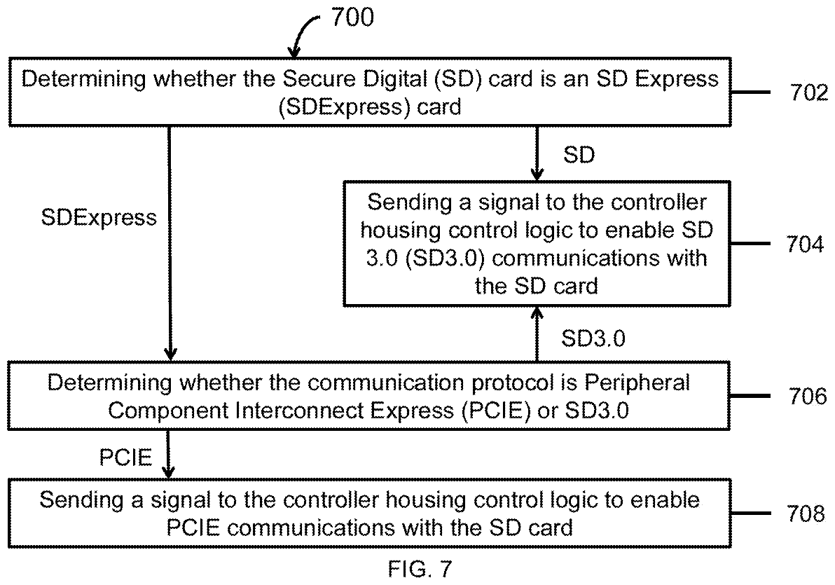

FIG. 7 is a flow diagram of a method 700 for enabling a communication protocol with an SD card, in accordance with various examples. The method 700 may be performed, for instance, by the processor 110, 408. The method 700 includes determining whether the SD card is an SDExpress card (702). The method 700 also includes sending a signal to control logic of the controller to enable SD3.0 communications with the SD card (704). In addition, the method 700 includes determining whether the communication protocol is PCIE or SD3.0 (706). Additionally, the method 700 includes sending a signal to the control logic of the controller to enable PCIE communications with the SD card (708).

In operation, if the processor 110, 408 determines the SD card is not an SDExpress card, then the processor 110, 408 sends a signal to the control logic (e.g., 300) of the controller (e.g., 104) to enable SD3.0 communications with the SD card. If the processor 110, 408 determines the SD card is an SDExpress card, then the processor 100, 408 determines whether the communication protocol is PCIE or SD3.0. If the processor 110, 408 determines the communication protocol is PCIE, then the processor 110, 408 sends a signal to the control logic of the controller to enable PCIE communications with the SD card. If the processor 110, 408 determines the communication protocol is SD3.0, then the processor 110, 408 sends a signal to the control logic of the controller to enable SD3.0 communications with the SD card.

As discussed above with respect to FIGS. 1, 2, 4, and 6, the processor 110, 408 may determine a type of the card in the socket. The processor 110, 408 may read a register of the controller to determine a type of the card in the socket, in one example. In another example, the processor 110, 408 may read a register of the card in the socket. In some examples, if the processor 110, 408 determines the SD card is a legacy SD card, then the processor 110, 408 sends a signal to the control logic of the controller to enable SD3.0 communications with the legacy SD card.

In various examples, if the processor 110, 408 determines the SD card is an SDExpress card, then the processor 110, 408 may determine whether the communication protocol is PCIE or SD3.0 by reading a register comprising a default communication protocol stored on the storage device (e.g., 106) as discussed above with respect to FIGS. 1, 2, and 5. In other examples, the processor 110, 408 may determine the communication protocol by retrieving an identifier of the SDExpress card and comparing it to a list of identifiers stored on the storage device. For example, as discussed above with respect to FIG. 2, the communication protocol to utilize with the identified SDExpress card may be stored with the identifier of the SDExpress card. In yet other examples, the processor 110, 408 may determine the communication protocol by prompting the user, as discussed above with respect to FIGS. 2, 3, 4, 5, and 6.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

In the figures, certain features and components disclosed herein may be shown exaggerated in scale or in somewhat schematic form, and some details of certain elements may not be shown in the interest of clarity and conciseness. In some of the figures, in order to improve clarity and conciseness, a component or an aspect of a component may be omitted.

In the above discussion and in the claims, the terms “including” and “comprising” are used in an open-ended fashion, and thus should be interpreted to mean “including, but not limited to. . . . ” Also, the term “couple” or “couples” is intended to be broad enough to encompass both indirect and direct connections. Thus, if a first device couples to a second device, that connection may be through a direct connection or through an indirect connection via other devices, components, and connections. As used herein, including in the claims, the word “or” is used in an inclusive manner. For example, “A or B” means any of the following: “A” alone, “B” alone, or both “A” and “B.”

What is claimed is:

1. A system, comprising:
a socket;
a controller coupled to the socket;
a processor coupled to the controller;
a storage device coupled to the processor, the storage device comprising machine-readable instructions which, when executed, cause the processor to:
detect a Secure Digital (SD) card in the socket via the controller;
prompt a user to select a communication protocol to be utilized by the system when communicating with the SD card; and
enable the system to communicate with the SD card based on the user selection.

2. The system of claim 1, wherein the communication protocol is either Peripheral Component Interconnect Express (PCIE) or SD 3.0.

3. The system of claim 2, wherein execution of the machine-readable instructions causes the processor to, based on the selection of the PCIE communication protocol, send a signal to the controller to enable PCIE communications with the SD card.

4. The system of claim 2, wherein execution of the machine-readable instructions causes the processor to, based on the selection of the SD3.0 communication protocol, send a signal to the controller to enable SD3.0 communications with the SD card.

5. The system of claim 1, wherein execution of the machine-readable instructions causes the processor to prompt the user for the communication protocol after detecting an SDExpress card.

6. A non-transitory machine-readable medium storing machine-readable instructions which, when executed by a processor, cause the processor to:
detect a Secure Digital Express (SDExpress) card in a socket; and
prompt a user for a communication protocol to be utilized when communicating with the SDExpress card.

7. The non-transitory machine-readable medium of claim 6, wherein execution of the machine-readable instructions causes the processor to send a signal to set a control logic to enable SD 3.0 communications prior to detecting the SDExpress card in the socket.

8. The non-transitory machine-readable medium of claim 6, wherein the communication protocol is either Peripheral Component Interconnect Express (PCIE) or Secure Digital 3.0 (SD3.0).

9. The non-transitory machine-readable medium of claim 8, wherein execution of the machine-readable instructions causes the processor to, based on a selection of the PCIE communication protocol, send a signal to set a control logic to enable PCIE communications with the SDExpress card.

10. The non-transitory machine-readable medium of claim 8, wherein execution of the machine-readable instructions causes the processor to, based on a selection of the SD3.0 communication protocol, send a signal to set a control logic to enable SD3.0 communications with the SDExpress card.

11. A method, comprising:
detecting a Secure Digital (SD) card in a socket coupled to a controller;
determining whether the SD card is an SD Express (SDExpress) card; and
in response to a determination that the SD card is an SDExpress card, causing a prompt to a user for a communication protocol to be utilized during communication with the SDExpress card.

12. The method of claim 11, comprising, in response to a determination that the SD card is not an SDExpress card, sending a signal to a control logic of the controller to enable SD 3.0 communications with the SD card.

13. The method of claim 11, wherein the communication protocol is either Peripheral Component Interconnect Express (PCIE) or SD 3.0.

14. The method of claim 13, comprising, based on a selection of the PCIE communication protocol, sending a signal to control logic to enable PCIE communications with the SD card.

15. The method of claim 13, comprising, based on a selection of the SD 3.0 communication protocol, sending a signal to the controller to enable SD 3.0 communications with the SD card.
